(19) United States
(12) Patent Application Publication
(10) Pub. No.: US 2008/0239701 A1
(43) Pub. Date: Oct. 2, 2008

(54) Emergency light

(75) Inventor: Johnson Wu, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Holageo Enterprise Co., Ltd., Tainan Hsien (TW)

(21) Appl. No.: 11/727,703

(22) Filed: Mar. 28, 2007

(51) Int. Cl. F21V 25/00; F21L 4/00; F21V 33/00

(52) U.S. Cl. 362/95; 362/20; 362/183

(57) ABSTRACT

An emergency light combined with a faceplate base of a switch and a socket is installed inside the faceplate base and shoots light through a transparent faceplate set at the front of the faceplate base. Thus the emergency light is hidden behind the faceplate base, not needed to be fixed on a wall, with the power wire not exposed out of the switch and the socket. The emergency light includes a case, a lamp plate fixed in the case, a rechargeable battery attached at one side of the lamp plate, a cap closing on the case, a connecting base, plural lamps and plural indicating lamps arranged on the lamp plate, a power connecting base fixed on an outer side of the case.

### BACKGROUND OF THE INVENTION

1. Field of the Invention

This invention relates to an emergency light combined with a faceplate base of a switch and a socket, particularly to one unnecessary to install on a wall and its wire not needed to expose out on a wall for connecting it with the switch and the socket, convenient to install, not occupying much space, not damaging the neat surface of a wall, as the emergency light is hidden inside the faceplate base of the switch and the socket.

2. Description of the Prior Art

A conventional emergency light is generally installed on a wall in a parlor, a stairwell, or a passageway leading to a shelter, for shining temporarily in case of power cut, and FIG. 1 shows a conventional emergency lamp.

It includes a case 1, a battery to be stored in the case 1, and a wire connected between the case 1 and a switch socket fixed on a wall, an automatic AC-DC changeover switch for charging the battery automatically and stopping charge when the electric volume is charged full. Further, a shining lamp 2 is positioned on the case, normally turned off and lit up in case of power cut.

However, a traditional emergency light is commonly hung on a wall, with its wire exposed on a wall and connected to a socket set on the wall, inconvenient for installing, needing much work, and looking not so decent with its wire exposing out on the wall.

### SUMMARY OF THE INVENTION

This invention has been devised to offer an emergency light unnecessary to be installed on a wall, thus not damaging the outer look of a wall, as it is directly connected with a faceplate base of a switch and a socket, hidden behind the faceplate base of the switch and the socket.

The feature of the invention is that an emergency light is fixed inside a faceplate base of a switch and a socket, and the power terminal of the emergency light is connected to the switch and the socket, so when the electricity supply in the area is normal, the battery of the emergency light can automatically be charged by the electricity through the switch and the socket.

When the power in an area is cut off, the emergency light can be lit up immediately by the battery, and shining through the transparent faceplate of the switch and the socket temporarily. As it is hidden behind the faceplate base of the switch and the socket, needless to be installed on a wall directly, not damaging the decent outer look of the wall.

### BRIEF DESCRIPTION OF DRAWINGS

This invention will be better understood by referring to the accompanying drawings, wherein:

FIG. 1 is a perspective view of a conventional emergency light;

FIG. 2 is a perspective view of an emergency light in the present invention;

FIG. 3 is a rear view of the emergency light in the present invention;

FIG. 4 is a side view of the emergency light in the present invention;

FIG. 5 is a front view of the emergency light in the present invention;

FIG. 6 is an exploded perspective view of the emergency light in the present invention;

FIG. 7 is a front view of the emergency light in the present invention;

FIG. 8 is a cross-sectional view of the line A-A in FIG. 7; and,

FIG. 9 is a cross-sectional view of the line B-B in FIG. 7.

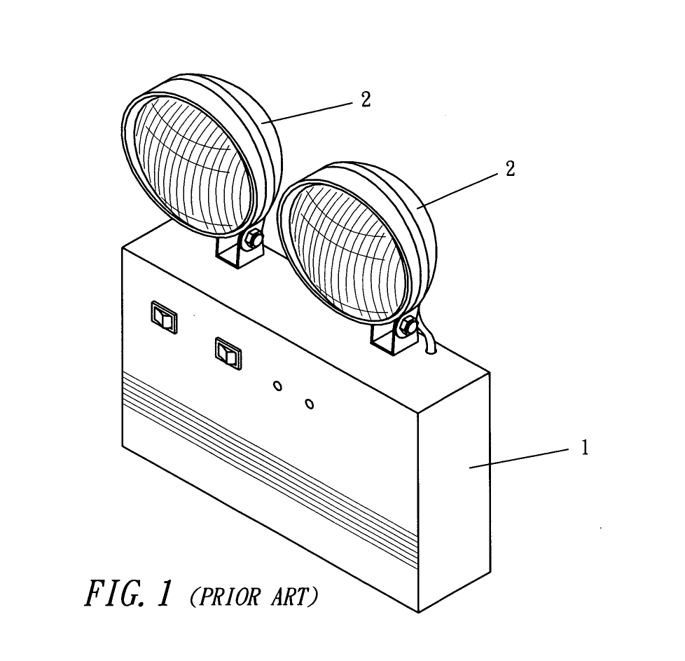

### DETAILED DESCRIPTION OF THE PREFERRED EMBODIMENT

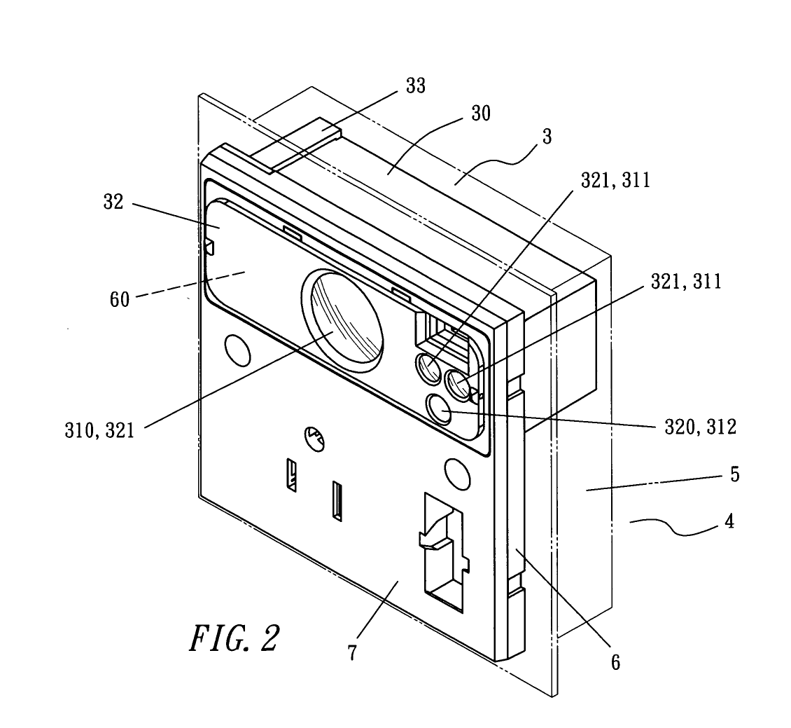

A preferred embodiment of a emergency light in the invention, as shown in FIG. 2, is fixed inside a faceplate base 4 of a switch and a socket, which is to be installed in a steel case 5 embedded in a wall, and a power wire is connected in the steel case 5, and a switch faceplate 6 is fixed on a front side of the steel case 5, with the power wire hidden in the steel case 5.

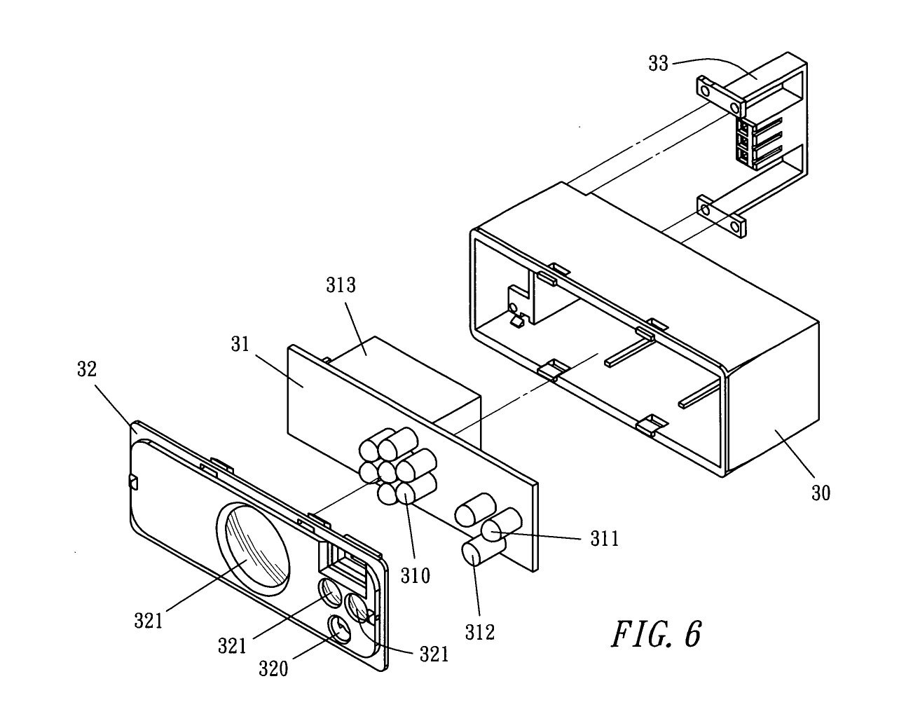

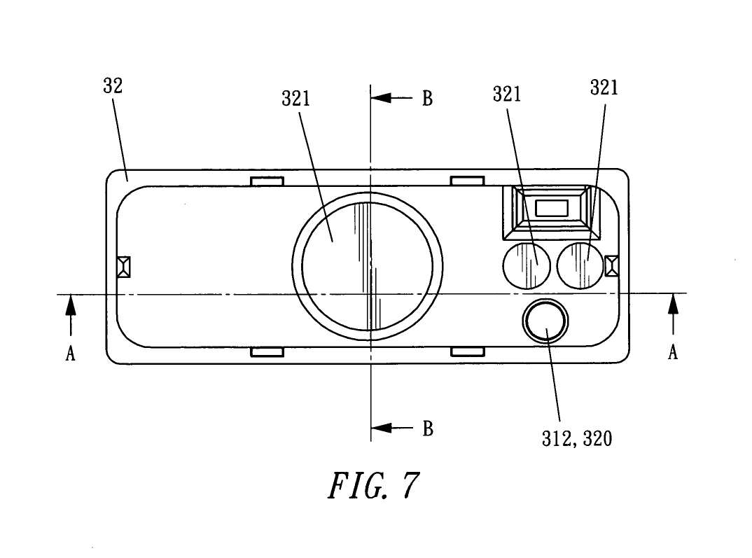

The emergency light 3, as shown in FIG. 6, is formed as a flashlight, inserted in the steel case 5 as shown in FIG. 4, having the same power as the faceplate base 4 of a switch and a socket does. The switch faceplate 6 has a hole 60 facing to the emergency light 3 as shown in FIG. 5, with a transparent cover 7 fixed or locked on the switch faceplate 6 as shown in FIG. 4. So the emergency light 3 is covered in suck a way that the light beam of the emergency light 3 may shoot out through the transparent cover 7. When the emergency light 3 is taken out of the steel case 5, it can be used as a flashlight, and the transparent cover 7 is taken off the hole 60 of the switch faceplate 6 in case of taking out the emergency light 3. After used as a flashlight, the emergency light 3 can be put back in the steel case 5 through the hole 60.

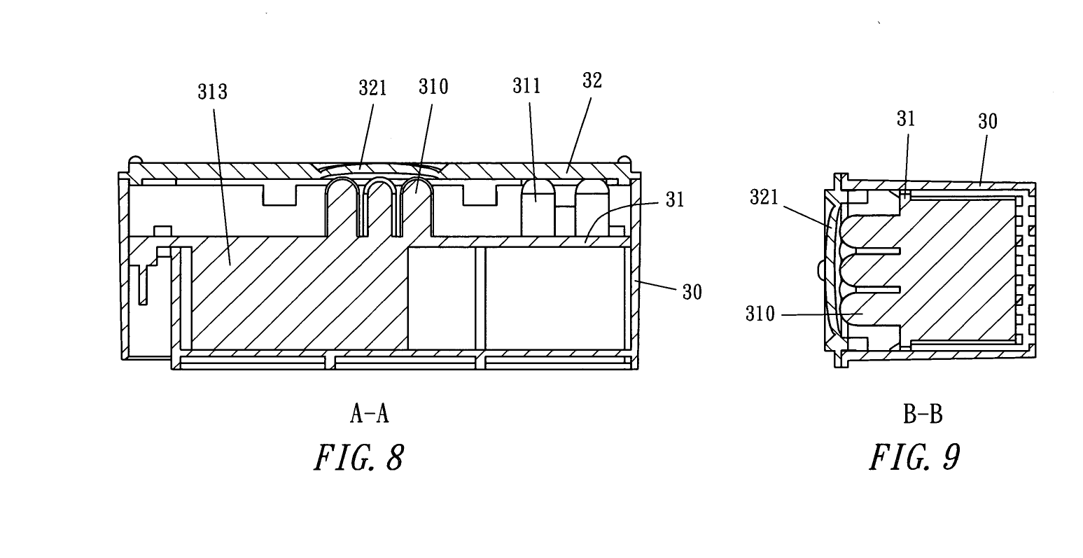

The emergency light 3, as shown in FIG. 6, is composed of a case 30 with an opening facing to the switch faceplate 6, a lamp plate 31 fitted in the case 30 and having plural lamps 310 (such as LEDs), plural indicating lamps 311 for charging and power-cut as shown in FIGS. 8 and 9, a changeover switch 312, and a rechargeable battery 313 positioned at a side of the lamp plate 31.

Next the emergency light 3 is further composed of a cap 32 and a power connecting base 33, and the cap 32 closes on the upper opening of the lamp case 30, provided with a hole 320, two transparent windows 321, 7.

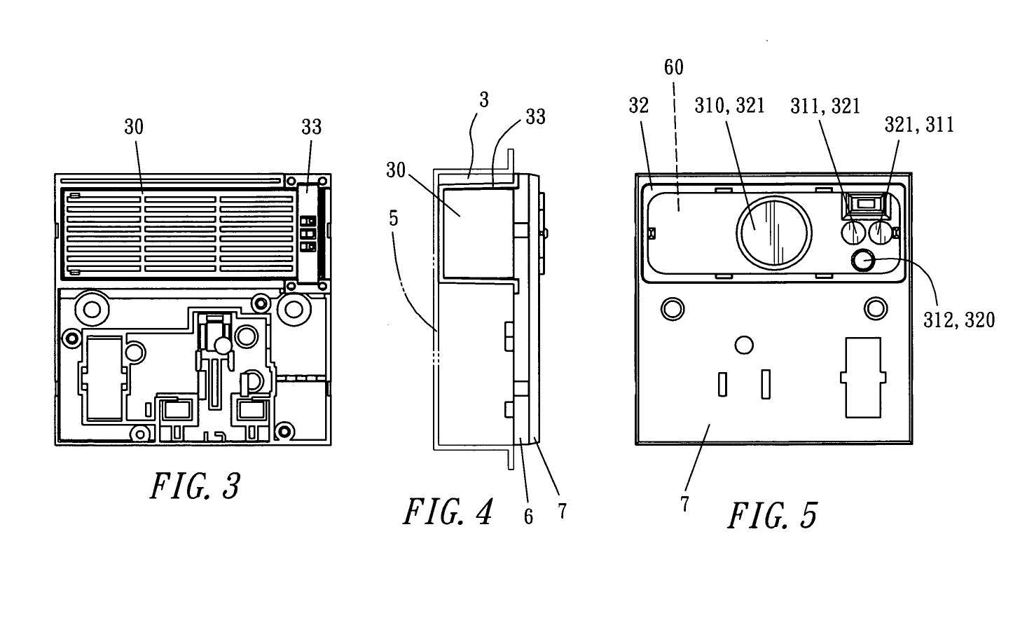

The power connecting base 33 is fixed on an outer wall of the case 30 as shown in FIG. 3, having one end connected to the electric circuit of the lamp plate 31 and the other end connected to the power wire in the steel case 5.

After the components described above are combined together, the emergency light 3 is finished in assembly, and normally inserted through the hole 60 and installed in the steel base 5 and connected to the power by an inserting mode

If the power supply is normal, the emergency light is not lit up and the battery 313 is charged continually, with the indicating charge lamp 311 lit up; if the power is out, the lamps 310 are lit up by the battery 313 and the other indicating lamp 311 is also lit up to show the power being out. The light beam of the lamps 310 then shoots out through the transparent window 321, the hole 60 of the switch faceplate 6 and the transparent cover 7 for emergently shining. In case the emergency light 3 is to be used as a flashlight, it can be taken through the hole 60 out of the steel case 5.

After the emergency light 3 is finished in using as a flashlight, the transparent cover 7 is again closed on the switch faceplate 6 and tightened, with the hole 60 also closed, so a finger could not extend in the faceplate base 4 to touch the electric current even if the finger might touch the faceplate base 4, by the transparent cover 7 hampering the finger.

Moreover, the emergency light 3 is made as a flashlight, but can be fixed immovably in the faceplate base, not to be taken out.

While the preferred embodiment of the invention has been described above, it will be recognized that various modifications may be made therein and the appended claims are intended to cover all such modifications that may fall within the spirit and scope of the invention.

1. An emergency light combined with a faceplate base having a faceplate base power terminal, comprising:
an emergency light power terminal disposed on said emergency light and configured to be connected to the power terminal of said faceplate base:
a battery connected to the emergency light: wherein the battery is configured to be charged by the power from the power terminal of said faceplate base while said emergency light is not lit up;
said emergency light is removeably installed inside said faceplate base and is a handheld flashlight light when removed from said faceplate base;
a transparent faceplate provided on said faceplate base;
wherein said emergency light powered by said battery to provide illumination through the transparent faceplate of said faceplate base in case of power of said faceplate base is out, and
wherein said emergency light is housed within said faceplate base when not in use as a handheld flashlight.

2. (canceled)

3. The emergency light of claim 1 further comprising:
a switch faceplate provided on the faceplate base;
a case provided with an opening facing to said switch faceplate;
a lamp plate installed in said case and having a plurality of lamps to be lit up in emergency, a plurality of indicating lamps and a changeover switch installed on a surface of said lamp plate facing to said switch faceplate, said indicating lamps lit up for indicating respectively said battery under charge and power cut;
a cover closing on said opening of said case and provided with a hole and transparent windows facing to said changeover switch, said lamps and said indicating lamps respectively;
a power connecting base fixed at an outside of said case and having one end connected to an electric circuit of said lamp plate and another end connected to said power terminal of said faceplate base;
said switch faceplate provided with a through hole facing to said flashlight-type emergency light; and
a transparent protective cover tightly covered on an outer side of said switch faceplate so that said flashlight-type emergency lamp may be taken out of said faceplate base through said through hole and used as a flashlight, with said transparent protective cover taken off.
